(19) United States
(12) Patent Application Publication
(10) Pub. No.: US 2025/0023039 A1
(43) Pub. Date: Jan. 16, 2025

(54) CATHODE MATERIAL BASED ON DISORDERED ROCK SALT STRUCTURE AND SECONDARY BATTERY COMPRISING THE SAME

(71) Applicant: THE ROYAL INSTITUTION FOR THE ADVANCEMENT OF LEARNING/MCGILL UNIVERSITY, Montréal (CA)

(72) Inventors: Jinhyuk LEE, Montreal (CA); Dong Hwa Seo, Ulsan (KR); Eun Ryeol Lee, Ulsan (KR); Dae-Hyung Lee, Ulsan (KR); Sang Wook Park, Ulsan (KR)

(21) Appl. No.: 18/770,049

(22) Filed: Jul. 11, 2024

(30) Foreign Application Priority Data
Jul. 11, 2023 (KR) 10-2023-0089961

(51) Int. Cl. H01M 4/505; H01M 4/02; H01M 4/131; H01M 4/62; H01M 10/052

(52) U.S. Cl. CPC H01M 4/505; H01M 4/131; H01M 4/622; H01M 4/625; H01M 10/052; H01M 2004/021; H01M 2004/028

(57) ABSTRACT

There is provided a cathode comprising a disordered rock salt-cathode active material, a carbon nanotube-based conductive material and a binder. The disordered rock salt-cathode active material has a composition as per Chemical Formula 1:

Li_{0.4+x}M1_{y}M2₂O₂₋ₖFₖ (1)

wherein, 0<x≤1.6, 0<y≤1, 0≤z≤1, 0≤k≤0.66 and (x+y+z)≤1.6, and wherein M1 is a redox center selected from the group consisting of Mn, Ni, V, Co, Fe, Ir, Cr, Ru, Mo, and combinations thereof, and M2 is a d⁰ transitional metal selected from the group consisting of Ti, Zr, V, Nb, Sn, Mo and combinations thereof.

### CROSS-REFERENCE TO A RELATED APPLICATION

This disclosure claims priority from Korean Application Number 10-2023-0089961 filed on Jul. 11, 2023 which is incorporated by reference in its entirety.

### TECHNICAL FIELD

This disclosure relates to the field of cathode materials and secondary batteries containing same.

### BACKGROUND OF THE ART

The replacement of fossil fuels to reduce the environmental pollution they cause is an ongoing effort. Fossil fuels are often used as an energy and this energy source is being replaced in certain industries by electric energy. To support the use of electric energy which can advantageously come from renewable sources, the use of batteries to store and discharge the electrical energy has become more and more prevalent. The cathode material used for the battery is for example based on LiNiₓCo_{y}Mn_{z}O₂ (where x+y+z=1). There are however limitations with the use of such transitional metals, in particular there are limitations with regards to the energy density. To palliate to these deficiencies, a lithium-excess disordered rocksalt material was developed.

The advantage of a lithium-excess disordered rocksalt cathode material is its high energy capacity which can for example be around 1000 Wh/kg. Unfortunately, due to low electrical conductivity of the material, there is a need for the use of a large amount of carbon-based conductive material (e.g., carbon black) in a concentration of from 10 to 20% in the cathode. As a result, the energy density at an actual cathode level is reduced to around 700 Wh/kg, and the high energy density characteristic which is the advantage of the lithium-excess disordered rocksalt cathode material is lost. Accordingly, although the lithium-excess disordered rocksalt cathode material has shown an improved energy capacity, it is difficult to practically implement at the electrode level. Therefore, in order to implement high energy density performance of disordered rocksalt cathode materials, it would be desirable to improve their electrical conductivity characteristics while maintaining their increased energy capacity.

### SUMMARY

In one aspect, there is provided a cathode comprising: a disordered rock salt-cathode active material having a composition as per Chemical Formula 1:

Li_{0.4+x}M1_{y}M2₂O₂₋ₖFₖ (1)
wherein, 0<x≤1.6, 0<y≤1, 0≤z≤1, 0≤k≤0.66 and (x+y+z)≤1.6, and wherein M1 is a redox center selected from the group consisting of Mn, Ni, V, Co, Fe, Ir, Cr, Ru, Mo, and combinations thereof, and M2 is a d⁰ transitional metal selected from the group consisting of Ti, Zr, V, Nb, Sn, Mo and combinations thereof;
a carbon nanotube-based conductive material; and
a binder.

In some embodiments, the disordered rocksalt-cathode active material has a structure included in a cubic Fm-3m space group having a peak of the (400) plane around 45 degrees (2θ) in an X-ray diffraction (XRD) pattern, or has a structure included in a cubic Fd3m space group having a peak of the (400) plane around 45 degrees (2θ) and a peak of the (111) plane around 20 degrees (2θ) in the XRD pattern. In some embodiments, the disordered rock salt-cathode active material is a partial spinel disordered rock salt material corresponding to the cubic Fm-3m space group.

In some embodiments, M1 is selected from the group consisting of Mn, V, Cr, Mo, Ni, Co, and combinations thereof.

In some embodiments, M1 is selected from the group consisting of Mn, Ni, Co, and combinations thereof.

In some embodiments, M1 is Mn.

In some embodiments, M2 is selected from the group consisting of Ti, Nb and combinations thereof.

In some embodiments, the binder is selected from poly(vinylidene fluoride) (PVDF), polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluorochloroethylene, polyvinylidene fluoride-co-ethylene, ethylene/tetrafluoroethylene copolymers (ETFE), fluorinated ethylene/propylene copolymers (FEP), tetrafluoroethylene/perfluoroalkoxyvinyl copolymers (PFA), tetrafluoroeth-ylene/hexafluoropropylene/vinylidene fluoride terpolymers (THV), perfluoro rubbers (PFR), glassy amorphous fluoropolymers, Polytetrafluoroethylene (PTFE), styrene-butadiene rubber (SBR), sodium salt of carboxymethyl cellulose (CMC), poly(acrylic acid) (PAA) and poly(amide imide) (PAI) and combinations thereof.

In some embodiments, the carbon nanotube-based conductive material comprises a multi-walled carbon nanotube (MWCNT), a single-walled carbon nanotube (SWCNT), or both. In some embodiments, the carbon nanotube-based conductive material consists of a multi-walled carbon nanotube (MWCNT), a single-walled carbon nanotube (SWCNT), or both.

In some embodiments, the carbon nanotube-based conductive material has a diameter of 1 nm to 20 nm and a length of 1 μm to 50 μm.

In some embodiments, the carbon nanotube-based conductive material comprises a carbon nanotube-based conductive material (A) having an aspect ratio (length/diameter) of 50 or less, a carbon nanotube-based conductive material (B) having an aspect ratio (length/diameter) of 50 to 50,000, or both (A) and (B). In some embodiments, a mass ratio of the carbon nanotube-based conductive material (A) to the carbon nanotube-based conductive material (B) is from 1:1 to 1:10.

In some embodiments, a bulk volume of the conductive material is 1 cm³/g to 100 cm³/g.

In some embodiments, a weight of the disordered rock salt-cathode active material: the conductive material: the binder is 70+x:20−y:z, wherein, 0<x≤26, 0<y≤18, 2≤z≤10 and (x−y+z)=10.

In some embodiments, x is 5≤x≤26, or x is 10≤x≤26.

In a further aspect, there is provided a secondary battery comprising the cathode as defined herein, an anode and an electrolyte. In some embodiments, the secondary battery further comprises a separator. In some embodiments, the secondary battery has an energy density that is from 400 Wh/kg-_{cathode} to 1000 Wh/kg-_{cathode}.

Many further features and combinations thereof concerning the present improvements will appear to those skilled in the art following a reading of the instant disclosure.

### DESCRIPTION OF THE DRAWINGS

FIG. 1A is a FIG scanning electron microscope (SEM) image of a carbon black (CB) conductive material.

FIG. 1B is a SEM image of a multi-walled carbon nanotube (MWCNT) conductive material.

FIG. 2A is a SEM image of an electrode having a carbon black (CB) conductive material and a composition as per the ratio: active material (Li_{1.68}Mn_{1.30}Ti_{0.3}O_{3.7}F_{0.3} (LMOF)):conductive material:binder=80:10:10.

FIG. 2B is a SEM image of an electrode having a multi-walled carbon nanotube (MWCNT) conductive material and a composition as per the ratio: active material (LMOF):conductive material:binder=80:10:10.

FIG. 3A is a graph showing a voltage curve and life characteristics for a ratio of 70:20:10 of active material (LMOF):conductive material (CB):binder (PVDF).

FIG. 3B is a graph showing the capacity in function of cycle numbers for a ratio of 70:20:10 of active material (LMOF):conductive material (CB):binder (PVDF).

FIG. 3C is a graph showing a voltage curve and life characteristics for a ratio of 80:10:10 of active material (LMOF):conductive material (CB):binder (PVDF).

FIG. 3D is a graph showing the capacity in function of cycle numbers for a ratio of 80:10:10 of active material (LMOF):conductive material (CB):binder (PVDF).

FIG. 3E is a graph showing a voltage curve and life characteristics for a ratio of 90:5:5 of active material (LMOF):conductive material (CB):binder (PVDF).

FIG. 3F is a graph showing the capacity in function of cycle numbers for a ratio of 90:5:5 of active material (LMOF):conductive material (CB):binder (PVDF).

FIG. 4A is a graph showing a voltage curve and life characteristics for a ratio of active material:conductive material:binder when using a multi-walled carbon nanotube (MWCNT) as the conductive material and partial spinel DRX LMOF material as the active material.

FIG. 4B is a graph showing the capacity in function of cycle numbers for a ratio of active material:conductive material:binder when using a multi-walled carbon nanotube (MWCNT) as the conductive material and partial spinel DRX LMOF material as the active material.

FIG. 4C is a graph showing a voltage curve and life characteristics for a ratio of active material:conductive material:binder when using a multi-walled carbon nanotube (MWCNT) as the conductive material and Full-DRX material as the active material.

FIG. 4D is a graph showing the capacity in function of cycle numbers for a ratio of active material:conductive material:binder when using a multi-walled carbon nanotube (MWCNT) as the conductive material and Full-DRX material as the active material.

FIG. 5A is a graph showing the full-cell data of commercial Ni-rich NCM material based on the ratio of active material:conductive material (MWCNT):binder being 92:04:04 (LiNi_{0.82}Co_{0.11}Mn_{0.07}O₂ material (NCM 82).

FIG. 5B is a graph showing the full-cell data of partial spinel DRX material Li_{1.68}Mn_{1.30} Ti_{0.3}O_{3.7}F_{0.3} (T30) based on the ratio of active material:conductive material (MWCNT):binder being 92:04:04.

FIG. 5C is a graph showing the full-cell data of partial spinel DRX material Li_{1.68}Mn_{1.15}Ti_{0.45}O_{3.7}F_{0.3} (T45) based on the ratio of active material:conductive material (MWCNT):binder being 92:04:04.

FIG. 6 shows a graph comparing an active material content and electrode energy density of a disordered rock salt structure-cathode material with those of commercial products.

### DETAILED DESCRIPTION

There is provided a cathode comprising a disordered rock salt structure and carbon nanotube-based conductive material which has an improved energy density at the electrode level. More specifically, the cathode according to the present disclosure comprises a disordered rock salt structure as the active material, a carbon nanotube-based conductive material, and a binder. It has been presently found that the use of a carbon nanotube-based conductive material as the conductive material in the cathode improves the energy density and induces an organic electronic network within the electrode.

The disordered rocksalt-cathode active material contemplated by the present disclosure is as per Chemical Formula 1:

Li_{0.4+x}M1_{y}M2₂O₂₋ₖFₖ (1).
where, 0<x≤1.6, 0<y≤1, 0≤z≤1, 0≤k≤0.66 and (x+y+z)≤1.6, M1 (redox center) is selected from the group consisting of Mn, Ni, V, Co, Fe, Ir, Cr, Ru, Mo and combinations thereof, and M2 (d⁰ transition metal) is selected from the group consisting of Ti, Zr, V, Nb, Sn, Mo and combinations thereof. In some embodiments, in chemical Formula 1, x can be: 0<x≤1.6, 0<x≤1.5, 0<x≤1.2, or 0<x≤1. In some embodiments, in Chemical Formula 1, the M1 (redox center) is selected from Mn, V, Cr, Mo, Ni and Co, preferably is selected from Mn, Ni and Co and more preferably is Mn. In some embodiments, in Chemical Formula 1, M2 (d⁰ metal) may include at least one of Ti, Zr, V, Nb, Sn and Mo or any combinations of two or more thereof. In some cases, M2 (d⁰ metal) is selected from Ti, Nb and combinations thereof.

The cathode of the present disclosure can be defined by a weight ratio (mass ratio) of the disordered rocksalt-cathode active material:conductive material:binder as being (70+x):(20−y):z, where 0<x≤26, 0<y≤18, 2≤z≤10 and (x−y+z)=10 (i.e. the sum of the three components of the ratio must total 100).

In some embodiments, the disordered rocksalt-cathode active material has a structure included in a cubic Fm-3m space group having a peak of the (400) plane around 45 degrees (2θ) in an X-ray diffraction (XRD) pattern, or has a structure included in a cubic Fd3m space group having a peak of the (400) plane around 45 degrees (2θ) and a peak of the (111) plane around 20 degrees (2θ). In some examples, the disordered rocksalt-cathode active material may be a partial spinel DRX material corresponding to the “Fd-3m space group”.

In some embodiments, the disordered rock salt-cathode active material may include at least one of Li_{1.68}Mn_{1.30}Ti_{0.3}O_{3.7}F_{0.3} and Li_{1.68}Mn_{1.15}Ti_{0.45}O_{3.7}F_{0.3} or a combination thereof (stoichiometric numbers can be divided by 2 as a simplification).

In some embodiments there is provided a secondary battery which comprises the cathode as described herein as well as, an anode, and an electrolyte. In one example, the energy density of the secondary battery may be 400 Wh/kg-_{cathode} to 1000 Wh/kg-_{cathode}.

In a preferred embodiment, the cathode of the present disclosure comprises a disordered rock salt structure-cathode material (DRX) as the active material and multi-walled carbon nanotube (MWCNT) as the conductive material.

The cathode of the present disclosure achieves high energy density while reducing the conductive material content compared to conventional carbon-based conductive materials (e.g., carbon black (CB) conductive material) by applying a carbon nanotube-based (e.g., multi-walled carbon nanotube (MWCNT)) conductive material.

In some embodiments, the carbon nanotube-based conductive material includes a carbon nanotube-based conductive material (A) having an aspect ratio (length/diameter) of 1000 or less, a carbon nanotube-based conductive material (B) having an aspect ratio (length/diameter) of 1000 to 10,000, or both (A) and (B). When both (A) and (B) are present, the mass ratio of (A) to (B) may be from 1:1 to 1:10. Generally, the bulk volume of the conductive material of the present disclosure is preferably from 1 cm³/g to 100 cm³/g.

There are many binders suitable for producing a cathode material, the binder is for example selected from the group consisting of poly(vinylidene fluoride) (PVDF), polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluorochloroethylene, polyvinylidene fluoride-co-ethylene, ethylene/tetrafluoroethylene copolymers (ETFE), fluorinated ethylene/propylene copolymers (FEP), tetrafluoroethylene/perfluoroalkoxyvinyl copolymers (PFA), tetrafluoroeth-ylene/hexafluoropropylene/vinylidene fluoride terpolymers (THV), perfluoro rubbers (PFR), glassy amorphous fluoropolymers, Polytetrafluoroethylene (PTFE), styrene-butadiene rubber (SBR), sodium salt of carboxymethyl cellulose (CMC), poly(acrylic acid) (PAA) and poly(amide imide) (PAI) and combinations thereof.

In some embodiments, the size of the disordered rocksalt-cathode active material may be from 50 nm to 500 nm. In some examples, for high energy implementation, the size may be a nano size of from 50 nm to 200 nm. Herein, the size may mean a length, a diameter, or a thickness based on particle shape. If the size is included within the above range, it is possible to organically secure a carbon nanotube-based conductive material and a percolating network and to improve energy density.

In some embodiments, when the carbon nanotube-based (CNT) conductive material is applied to the disordered rocksalt-cathode active material, the CNT conductive material may not only have a higher density electrode configuration within the cathode material or cathode composite, but also form an organic electronic network within the electrode. For example, the carbon nanotube-based conductive material includes a multi-walled carbon nanotube (MWCNT), a single-walled carbon nanotube (SWCNT), or both.

In some embodiments, the carbon nanotube-based conductive material has a diameter of 1 nm to 20 nm and a length of 1 μm to 50 μm. when included in the mentioned range, it is possible to implement high energy density by securing disordered rocksalt structure nanoparticles and a percolating network.

In some embodiments, the carbon nanotube-based conductive material may include a carbon nanotube-based conductive material (A) having an aspect ratio (length/diameter) of 1000 or less; 500 or less; 100 or less; 50 or less; or 45 or less; 40 or less; or 30 or less; a carbon nanotube-based conductive material (B) having an aspect ratio (length/diameter) of 50 to 50,000; more than 50 to 50,000; 100 to 50,000; 300 to 50,000; 500 to 50,000; 1,000 to 50,000; 3,000 to 50,000; 5,000 to 50,000; 10,000 to 50,000; 20,000 to 50,000; or 1000 to 10,000; or both. In some examples, minimum and/or maximum values may be selected from the aforementioned values. In some examples, the mass ratio of the carbon nanotube-based conductive material (A) to the carbon nanotube-based conductive material (B) may be 1:1 to 1:10. when included in the mentioned range, it is possible to secure disordered rocksalt structure nanoparticles and a percolating network and to lower the minimum amount of conductive material required for organic electronic exchange.

In some embodiments, the bulk volume of the carbon nanotube-based conductive material may be 1 cm³/g to 100 cm³/g; 5 cm³/g to 100 cm³/g; 10 cm³/g to 100 cm³/g; 20 cm³/g to 100 cm³/g; 40 cm³/g to 100 cm³/g; 50 cm³/g to 100 cm³/g; or 60 cm³/g to 100 cm³/g. A maximum or minimum value may be selected from the aforementioned values. Since the carbon nanotube-based conductive material provides a high bulk volume compared to conventional carbon-based conductive materials, a network is formed well between the conductive material and the active material, and the content of the conductive material may be reduced, but even though applying a low content of conductive material, high energy density can be implemented from an electrode level to a cell level.

The binder may include a fluorine-based binder, aqueous binder, or both. In some embodiments, the fluorine-based binder may include at least one of a poly(vinylidene fluoride) (PVDF)-based binder, a vinylidene fluoride copolymer (VDF)-based copolymer, styrene-butadiene rubber (SBR), sodium salt of carboxymethyl cellulose (CMC), poly(acrylic acid) (PAA), and poly(amide imide) (PAI), or a combination thereof. In some embodiments, the binder may include at least one of poly(vinylidene fluoride) (PVDF), polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluorochloroethylene, polyvinylidene fluoride-co-ethylene, ethylene/tetrafluoroethylene copolymers (ETFE), fluorinated ethylene/propylene copolymers (FEP), tetrafluoroethylene/perfluoroalkoxyvinyl copolymers (PFA), tetrafluoroeth-ylene/hexafluoropropylene/vinylidene fluoride terpolymers (THV), perfluoro rubbers (PFR), glassy amorphous fluoropolymers, Polytetrafluoroethylene (PTFE), styrene-butadiene rubber (SBR), sodium salt of carboxymethyl cellulose (CMC) or any combinations thereof. In some examples, the styrene-butadiene rubber (SBR) and the sodium salt of carboxymethyl cellulose (CMC) may be included in a mass ratio of 1:99 to 99:1; 10:90 to 70:30; or 20:80 to 60:40. In some examples, the poly(vinylidene fluoride) (PVDF) based binder to the styrene-butadiene rubber (SBR) binder may be included in a mass ratio of 1:99 to 99:1; 10:90 to 70:30; or 20:80 to 60:40. In some examples, the poly(acrylic acid) (PAA) to poly(amideimide) (PAI) may be included in a mass ratio of 1:99 to 99:1; 10:90 to 70:30; or 20:80 to 60:40. When included in the mentioned range, a network between the active material and the conductive material may be formed well in the cathode material, and a high energy density electrode or battery may be provided.

In some embodiments, the ratio (mass ratio) of the active material: the conductive material: the binder in the cathode material may be 70+x:20−y:z, wherein 0<x≤26, 0<y≤18, 2≤z≤10, and (x−y+z)=10. In some examples, x may be 0<x≤26; 0<x≤23; 0<x≤22; 0<x≤20; 0<x≤18; 0<x≤15; 0<x≤12; 0<x≤10; 0<x≤8; 0<x≤5; 0<x≤3 or 0<x≤2. In some examples, y may be 0<y≤18; 0<y≤16; 0<y≤15; 0<y≤14; 0<y≤12; 0<y≤10; 0<y≤8; 0<y≤6; 0<y≤5; 0<y≤4; or 0<y≤2. In some embodiments, x is 5≤x≤26, 10≤x≤26, 15≤x≤26, 18≤x≤26, 20≤x≤26, 21≤x≤26, or 22≤x≤26. In some embodiments, y is 5≤y≤18, 10≤y≤18, 11≤y≤18, 12≤y≤18, 13≤y≤18, or 14≤y≤18. In some examples, z may be 2≤z≤10; 2≤z≤9; 2≤z≤8; 2≤z≤7; 2≤z≤6; 2≤z≤5; 2≤z≤4; or 2≤z≤3. It should be noted that the sum of x−y+z is 10 such that the total is 100 (or in other words z=10−x+y).

In some embodiments, the cathode material may further include a solvent, which can be selected from an organic solvent and water, such as at least one of acetone, tetrahydrofuran, methylenechloride, chloroform, dimethylformamide, N-methyl-2-pyrrolidone (NMP), cyclohexane, and water, or any combination thereof. The cathode material may be mixed in a solvent-free state (e.g., about 0%) without including a solvent, or may be mixed by applying a solvent of more than 0%; 5% or more; 10% or more; 30% or more; 35% or less; 25% or less; 15% or less; or 3% or less. In some examples, the solvent may be removed when manufacturing the electrode.

In some embodiments, there is provided a secondary battery and a method of producing the secondary battery, wherein the secondary battery comprises a cathode material which comprises the disordered rocksalt-cathode active material, an anode, and an electrolyte or separator. The cathode energy density is improved by using a carbon nanotube-based (e.g., multi-walled carbon nanotube (MWCNT)) as the carbon-based conductive material. The energy density of the secondary battery of the secondary battery as described herein may be from 400 Wh/kg-_{cathode} to 1000 Wh/kg-_{cathode}; from 500 Wh/kg-_{cathode} to 1000 Wh/kg-_{cathode}; from 600 Wh/kg-_{cathode} to 1000 Wh/kg-_{cathode}; or from 700 Wh/kg-_{cathode} to 1000 Wh/kg-_{cathode} (mass density).

In some embodiments, the cathode may be a sheet or film coated or applied on a substrate or current collector. In such embodiments, the loading amount of the active material in the cathode may be 0.1 mAh/cm² to 10 mAh/cm².

In some embodiments, the separator can comprise a single layer of a porous film made of a synthetic resin such as polytetrafluoroethylene, polypropylene or polyethylene, or a porous film made of ceramics, or laminating a plurality of layers thereof. In addition, the separator may include a porous film of non-woven fabric or cellulose, and the like.

In some embodiments, the anode is a sheet-shaped member formed by applying and drying an anode composite paste to the surface of a metal foil current collector such as copper. The anode active material may include materials containing lithium, such as metallic lithium and lithium alloys; organic compound sintered bodies, such as natural graphite, artificial graphite, and phenol resin; and powdered carbon materials, such as coke, but is not limited thereto. In some examples, the anode may be a metal foil (e.g., lithium metal foil) or a metal thin film.

In some embodiments, the electrolyte may be a non-aqueous electrolyte solution including an electrolyte salt; and a cyclic carbonate such as ethylene carbonate, propylene carbonate, butylene carbonate, and trifluoropropylene carbonate; a linear carbonate such as diethyl carbonate, dimethyl carbonate, ethyl methyl carbonate, and dipropyl carbonate; an ether compound such as tetrahydrofuran, 2-methyltetrahydrofuran, and dimethoxyethane; a sulfur compound such as ethyl methyl sulfone and butane sultan; or a phosphorus compound such as triethyl phosphate or trioctyl phosphate.

### EXAMPLE

### Preparation of Cathode Material

The preparation of a cathode was performed with mechanochemical synthesis and solid-state synthesis. The mechanochemical synthesis was performed by applying energy for a long period of time using a high-energy ball mill enclosed with balls for a ball mill in a ball mill vessel with an inert gas (Ar) atmosphere using a metal oxide (MₓO_{y}) or metal fluoride (MₓF_{y})-based precursor at a stoichiometric ratio. The balls for the ball mill had a weight ratio of balls/precursor of from 15:1 to 30:1. During the synthesis, energy was controlled by rpm, in the range of 400 rpm to 700 rpm. The synthesis time was from 20 hours to 50 hours. The solid-state synthesis was performed by mixing precursors based on metal oxides (MₓO_{y}) or metal fluorides (MₓF_{y}) dissolved in ethanol at a stoichiometric ratio using a high-energy ball mill enclosed with balls for a ball mill in a ball mill vessel by applying energy for a short period of time. During mixing, the energy was controlled by rpm, in the range of 200 rpm to 400 rpm. The balls for the ball mill also had a weight ratio of balls/precursor of from 15:1 to 30:1. The mixing time was from 2 hours to 20 hours. After mixing, ethanol was filtered out through a filtering process and high-temperature synthesis was performed using a furnace. The high-temperature synthesis temperature ranged from 700° C. to 1200° C. The synthesis time was from 5 hours to 48 hours. The active material synthesized by the high-temperature synthesis was finally pulverized for 2 hours using SPEX™ ball mill equipment for nanosizing.

### Manufacture of Battery

The cathode mixture was prepared by adding lithium manganese based oxyhalide (active material) prepared as per the above and MWCNT (conductive material) in a Premium Line 7 device from FRISTCH™ at various weight ratios (active material:conductive material=90:5, 92:4, 94:3, 96:2), and mixing the materials at 300 rpm for 30 minutes to evenly mix the MWCNT on the surface of the lithium manganese based oxyhalide.

The cathode was manufactured by mixing the prepared cathode active material and conductive material (MWCNT) composite and the binder in N-methylpyrrolidone (NMP) at various weight ratios (active material and conductive material composite:binder=95:5, 96:4, 97:3, 98:2) to prepare a cathode composite, the cathode was applied on an aluminum current collector, and then was dried and rolled to obtain a coated current collector.

The anode active material that was used was a 0.2 mm-thick lithium metal foil.

A lithium secondary battery was manufactured by interposing a separator between the cathode and the anode manufactured as described above to produce an electrode assembly, by inserting the electrode assembly into a battery can, and then injecting an electrolyte. The electrolyte was produced by dissolving LiPF₆ at a concentration of 1 M in a mixed solvent of ethylene carbonate (EC):dimethyl carbonate (DMC) in a volume ratio of 1:1.

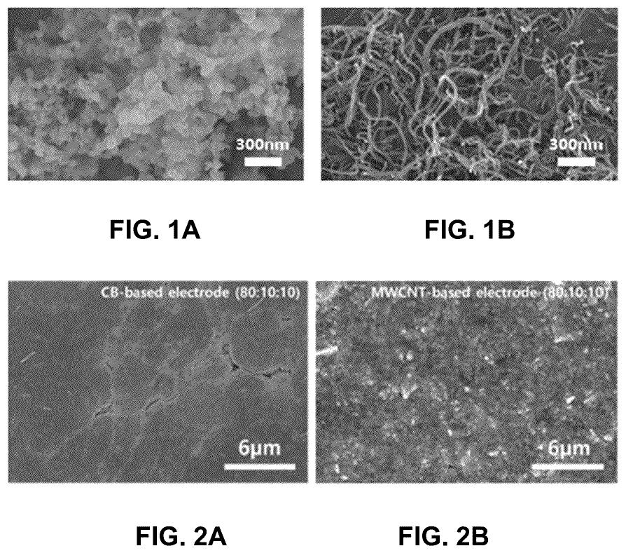

Due to a high bulk volume characteristic of multi-walled carbon nanotube as shown in FIGS. 1A-1B and 2A-2B, a higher density electrode configuration in the electrode composite was achieved, and an organic electronic network was also observed within the electrode.

Referring to FIGS. 2A-2B, MWCNT (˜4.35 cm³/g) not only has a bulk volume that is about 8 times more than that of CB (˜0.55 cm³/g), but it was shown to easily penetrate into pores within the electrode due to a rod-type shape. This is advantageous in configuring a dense three-dimensional network of electrons.

In contrast, conventional CB conductive materials are spherical particles with sizes of ˜100 nm, and the multi-walled carbon nanotube conductive material (MWCNT) has long rod-type nanoparticles and a larger bulk volume than CB. As a result, the multi-walled carbon nanotube uses multi-walled carbon nanotube (MWCNT) with a larger bulk volume instead of conventional CB conductive materials form an organic electronic network within the electrode.

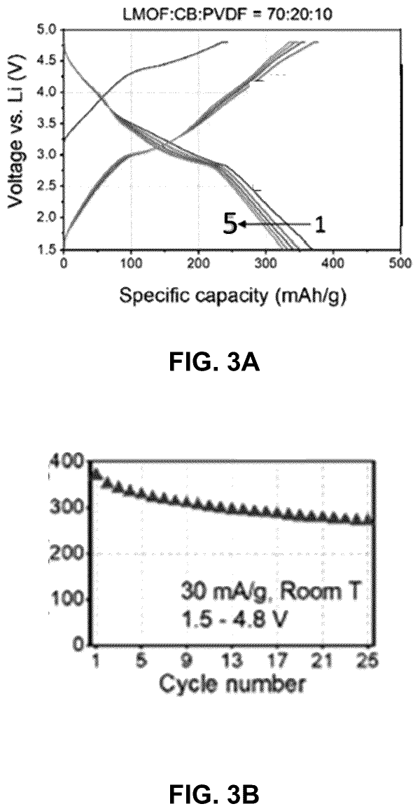

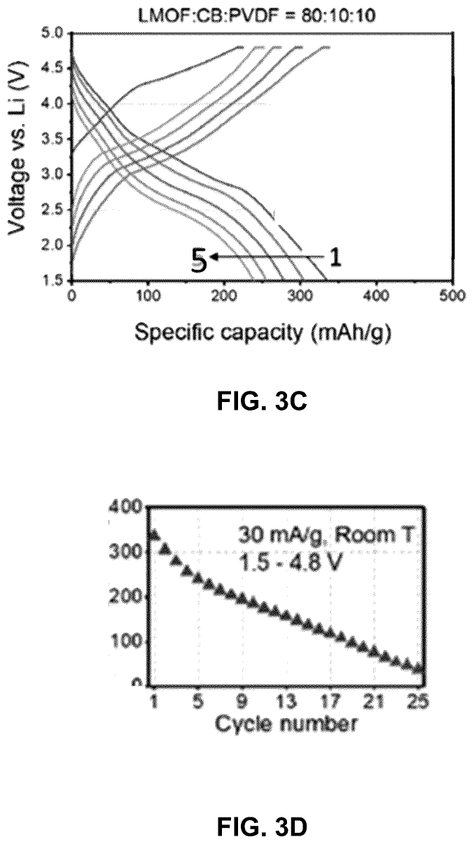

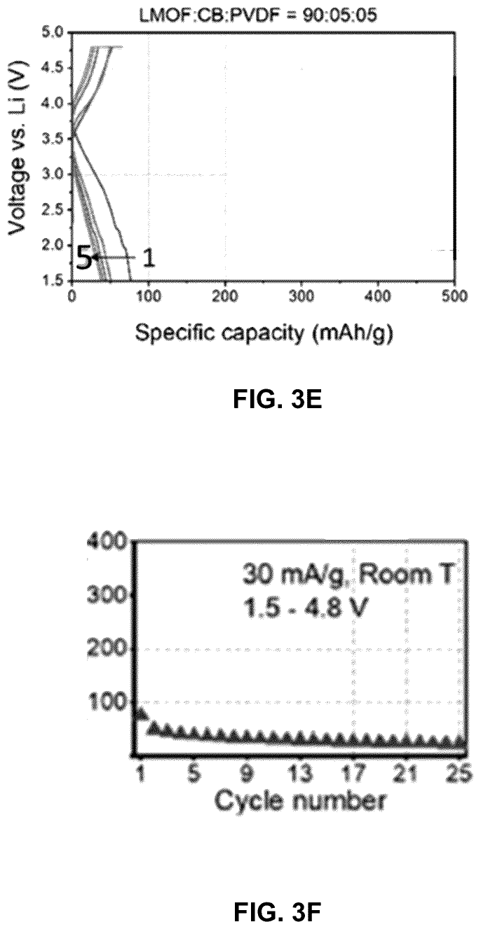

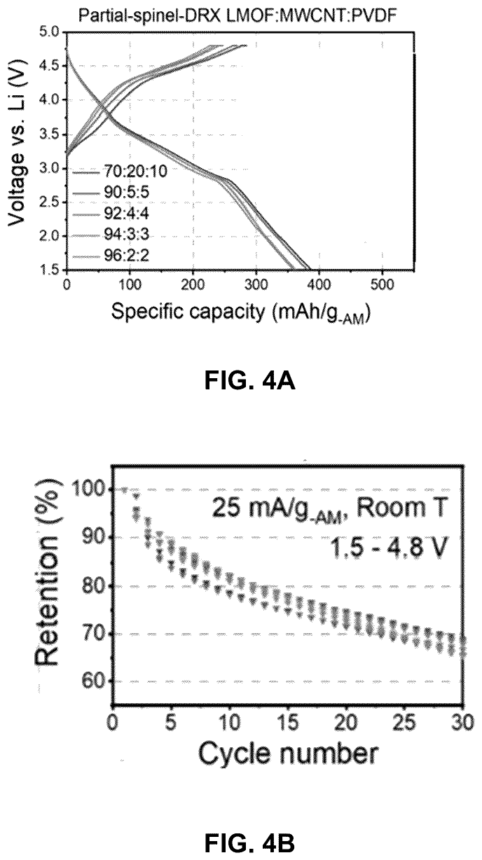

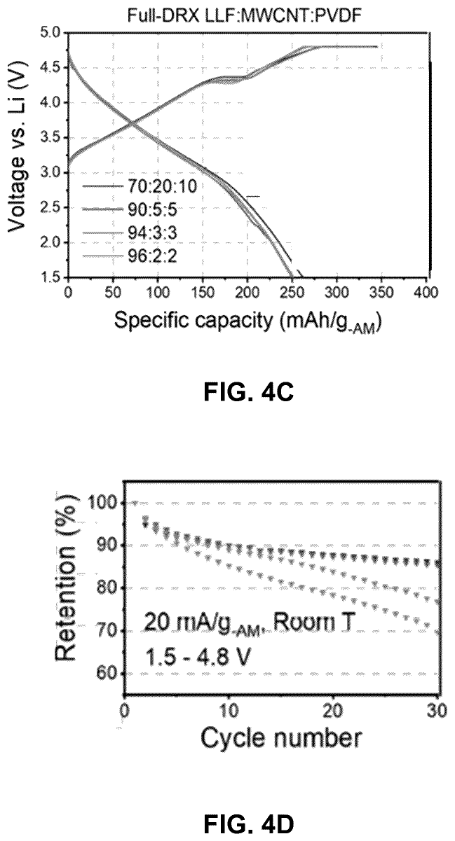

To confirm this result, the electrochemical characteristics at high active material ratios were compared when using a conventional CB conductive material (FIGS. 3A-3F) and an MWCNT conductive material (FIGS. 4A-4D). In FIGS. 4A-4D, the electrode energy density was dramatically increased by lowering the minimum amount of conductive material required for organic electron exchange of disordered rock salt structure nanoparticles (50 nm to 200 nm) to increase the active material ratio.

Therefore, the cathode material of the present disclosure achieved a high active material electrode configuration thanks to the multi-walled carbon nanotube conductive material, which allows to obtain a high-energy density electrode or battery.

For the design of the high-energy density electrode, electrochemical evaluation was conducted using the MWCNT conductive material compared to the conventional CB conductive material. In the case of using the conventional CB conductive material, when the amount of conductive material was reduced and the amount of active material was increased based on a condition of active material:conductive material:binder=70:20:10 (active material:conductive material:binder=80:10:10 and 90:5:5), partial spinel Li_{1.68}Mn_{1.30}Ti_{0.3}O_{3.7}F_{0.3} (LMOF) showed reduced first cycle capacity and deteriorated life characteristics.

In FIGS. 3A-3F, Li_{1.68}Mn_{1.30}Ti_{0.3}O_{3.7}F_{0.3} (LMOF) in combination with CB in different ratios showed reduced first cycle capacity and deteriorated life characteristics. On the other hand, when the MWCNT conductive material was used instead of the CB conductive material, it was shown (see FIGS. 4A-4D) that high capacity and stable life characteristics were obtained. The high capacity was maintained for a 70% active material ratio and even under a condition of 96% active material ratio (2% conductive material, 2% binder).

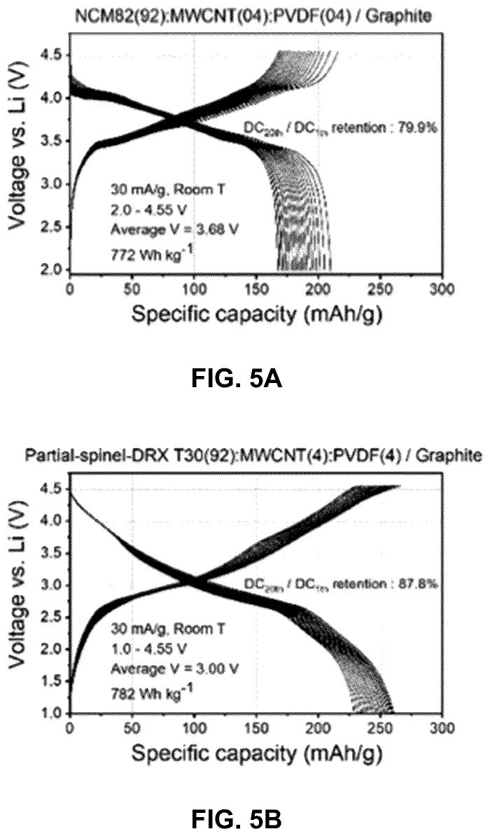

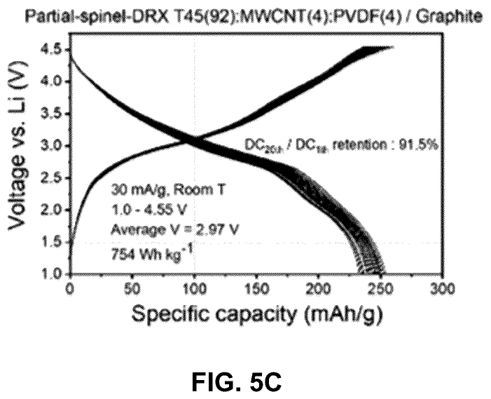

In addition, in FIGS. 5A-5C, an operating voltage was set to from 2.0 V to 4.55 V based on NCM 82 and a charging voltage was equally set to from 1.0 V to 4.55 V based on partial spinel Li_{1.68}Mn_{1.30}Ti_{0.3}O_{3.7}F_{0.3} (T30) and Li_{1.68}Mn_{1.15}Ti_{0.45}O_{3.7}F_{0.3} (T45) materials. Within the corresponding voltage driving, the partial spinel T30 and T45 materials had energy density higher than or similar to a commercial NCM 82 cathode and showed a better tendency in life characteristics.

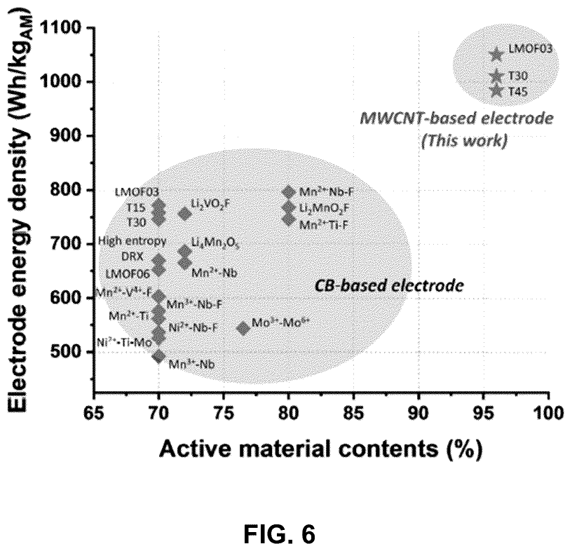

Full-cell performances of a commercial cathode LiNi_{0.82}Co_{0.11}Mn_{0.07}O₂ (NCM82) and partial spinel Li_{1.68}Mn_{1.30}Ti_{0.3}O_{3.7}F_{0.3} (T30) and Li_{1.68}Mn_{1.15}Ti_{0.45}O_{3.7}F_{0.3} (T45) DRX materials were evaluated under high-activity material electrode conditions of 92% active material. The results are provided in FIG. 6.

FIG. 6 shows that the disordered rock salt-cathode material-based system according to the present disclosure improves the energy density to a commercial level and provides the applicability as a next-generation cathode material.

What is claimed is:

1. A cathode comprising:
a disordered rock salt-cathode active material having a composition as per Chemical Formula 1:
Li_{0.4+x}M1_{y}M2_{z}O₂₋ₖFₖ (1)
wherein, 0<x≤1.6, 0<y≤1, 0≤z≤1, 0≤k≤0.66 and (x+y+z)≤1.6, and wherein M1 is a redox center selected from the group consisting of Mn, Ni, V, Co, Fe, Ir, Cr, Ru, Mo, and combinations thereof, and M2 is a d⁰ transitional metal selected from the group consisting of Ti, Zr, V, Nb, Sn, Mo and combinations thereof;
a carbon nanotube-based conductive material; and
a binder.

2. The cathode of claim 1, wherein the disordered rocksalt-cathode active material has a structure included in a cubic Fm-3m space group having a peak of the (400) plane around 45 degrees (2θ) in an X-ray diffraction (XRD) pattern, or has a structure included in a cubic Fd3m space group having a peak of the (400) plane around 45 degrees (2θ) and a peak of the (111) plane around 20 degrees (2θ) in the XRD pattern.

3. The cathode of claim 1, wherein M1 is selected from the group consisting of Mn, V, Cr, Mo, Ni, Co, and combinations thereof.

4. The cathode of claim 1, wherein M1 is selected from the group consisting of Mn, Ni, Co, and combinations thereof.

5. The cathode of claim 1, wherein M1 is Mn.

6. The cathode of claim 1, wherein M2 is selected from the group consisting of Ti, Nb and combinations thereof.

7. The cathode of claim 1, wherein the binder is selected from poly(vinylidene fluoride) (PVDF), polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluorochloroethylene, polyvinylidene fluoride-co-ethylene, ethylene/tetrafluoroethylene copolymers (ETFE), fluorinated ethylene/propylene copolymers (FEP), tetrafluoroethylene/perfluoroalkoxyvinyl copolymers (PFA), tetrafluoroeth-ylene/hexafluoropropylene/vinylidene fluoride terpolymers (THV), perfluoro rubbers (PFR), glassy amorphous fluoropolymers, Polytetrafluoroethylene (PTFE), styrene-butadiene rubber (SBR), sodium salt of carboxymethyl cellulose (CMC), poly(acrylic acid) (PAA) and poly(amide imide) (PAI) and combinations thereof.

8. The cathode of claim 1, wherein the carbon nanotube-based conductive material comprises a multi-walled carbon nanotube (MWCNT), a single-walled carbon nanotube (SWCNT), or both.

9. The cathode of claim 1, wherein the carbon nanotube-based conductive material consists of a multi-walled carbon nanotube (MWCNT), a single-walled carbon nanotube (SWCNT), or both.

10. The cathode of claim 1, wherein the carbon nanotube-based conductive material has a diameter of 1 nm to 20 nm and a length of 1 μm to 50 μm.

11. The cathode of claim 1, wherein the carbon nanotube-based conductive material comprises a carbon nanotube-based conductive material (A) having an aspect ratio (length/diameter) of 50 or less, a carbon nanotube-based conductive material (B) having an aspect ratio (length/diameter) of 50 to 50,000, or both (A) and (B).

12. The cathode of claim 11, wherein a mass ratio of the carbon nanotube-based conductive material (A) to the carbon nanotube-based conductive material (B) is from 1:1 to 1:10.

13. The cathode of claim 1, wherein a bulk volume of the conductive material is 1 cm³/g to 100 cm³/g.

14. The cathode of claim 2, wherein the disordered rock salt-cathode active material is a partial spinel disordered rock salt material corresponding to the cubic Fm-3m space group.

15. The cathode of claim 1, wherein a weight of the disordered rock salt-cathode active material: the conductive material: the binder is 70+x:20−y:z, wherein, 0<x≤26, 0<y≤18, 2≤z≤10 and (x−y+z)=10.

16. The cathode of claim 15, wherein x is 5≤x≤26.

17. The cathode of claim 15, wherein x is 10≤x≤26.

18. A secondary battery comprising the cathode of claim 1, an anode and an electrolyte.

19. The secondary battery of claim 18, further comprising a separator.

20. The secondary battery of claim 18, wherein the secondary battery has an energy density that is from 400 Wh/kg-_{cathode} to 1000 Wh/kg-_{cathode}.
